(19) United States
(12) Patent Application Publication
(10) Pub. No.: US 2013/0129935 A1
(43) Pub. Date: May 23, 2013

(54) Highly Transparent and Electrically Conductive Substrate

(71) Applicants: Mohshi Yang, Austin, TX (US); Zvi Yaniv, Austin, TX (US)

(72) Inventors: Mohshi Yang, Austin, TX (US); Zvi Yaniv, Austin, TX (US)

(73) Assignee: Applied Nanotech Holdings, Inc., Austin, TX (US)

(21) Appl. No.: 13/812,706

(22) PCT Filed: Jul. 25, 2011
(86) PCT No.: PCT/US11/45187

§ 371 Date: Jan. 28, 2013

Related U.S. Application Data
(60) Provisional application No. 61/367,619, filed on Jul. 26, 2010.
(60) Provisional application No. 61/394,420, filed on Oct. 19, 2010.

(51) Int. Cl. B05D 1/38; B05D 3/06

(52) U.S. Cl. CPC B05D 1/38; B05D 3/067
USPC 427/558

(57) ABSTRACT

A highly transparent and electrically conductive substrate is made by applying a conductive mesh over a transparent substrate, depositing a UV-curable transparent material over the conductive mesh and the transparent substrate, and exposing the UV-curable transparent material to a directional UV light from a UV light source positioned so that the UV light emitted from the UV light source travels through the transparent substrate before being received by the UV-curable transparent material, wherein the UV-curable transparent material is cured in response to exposure from the UV light except for those portions of the UV-curable transparent material masked from exposure to the UV light by the conductive mesh. Uncured portions of the UV-curable transparent material are removed, and a transparent conductive material layer is deposited over the cured UV-curable transparent material and conductive mesh.

This application claims priority to U.S. Provisional Patent Application Nos. 61/367,619 and 61/394,420, which are both hereby incorporated by reference herein.

### BACKGROUND INFORMATION

ITO (indium tin oxide) is extensively used as a transparent conductive layer for many applications such as displays, solar cells, etc. The deposition processes for producing high quality ITO films are costly and generally require high temperatures, which is not compatible with many substrates such as PET, soda-lime glass, etc. However, if lower temperatures are utilized in such processes, the ITO film loses its excellent properties, such transparency, electrical conductivity, or both.

Many companies and researchers have been working for a long time to find a replacement for ITO. Some examples are conductive polymers (e.g., Ormecon available from Agfa), CNT thin layers that provide high conductivity due to CNT properties but with too low of a density to provide enough transparency (e.g., as available from Eikos, Unydine, etc.), or similar metallic coatings that self-assemble by creating a random network of metallic interconnects with spaces between them, which may provide a satisfactory transparency in limited applications (e.g., as available from Cima).

A new approach was recently developed whereby an organized metallic mesh is produced on a transparent substrate such as PET, glass, etc. Generally, silver is utilized (e.g., as available from Fujifilm), although to lower the cost some companies are already experimenting with copper or copper alloys (e.g., as available from Sumitomo Osaka Cement). These substrates, depending on the density of the metallic mesh, can show suitable transparency with electrical conductivity.

Parallel solar cell tandems have been proposed as an approach to combine different technologies of solar cells in one unit, which basically would utilize different parts of the solar spectrum to convert this energy to electricity (see A. Zakhidov et al., “Modeling of series and parallel solar cell tandems,” American Physical Society, APS March Meeting 2010, Mar. 15-19, 2010, Abstract #L16.015, which is hereby incorporated by reference herein). A further published article proposed to use transparent carbon nanotube sheets as a possible charge collector for organic solar cells (see A. Zakhidov et al., “Transparent carbon nanotube sheets as 3-D charge collectors in organic solar cells,” Solar Energy Materials & Solar Cells, Vol. 91, pages 416-419 (2007), which is hereby incorporated by reference herein). Furthermore, in a presentation on Oct. 13, 2010 at the Lockheed Martin & CONTACT Program Joint Technical Symposium, which is hereby incorporated by reference herein, Prof. Zakhidov presented “Tandem Solar Cells with Carbon Nanotube Interlayers: Parallel OPV/DSC True Hybrids.” In this presentation, Prof. Zakhidov showed some potential improvements to the efficiency of this type of tandem solar cell. One of the problems with his proposal was that it did not utilize an electrode between the two types of cells that was very transparent and very electrically conductive. Due to the problems associated with depositing indium tin oxide (“ITO”), which is the transparent electrode of choice for use on different substrates at low temperatures and also the prohibitive cost favorite, a very significant problem to overcome is to achieve this intermediate electrode for collecting charges without relying upon ITO.

An issue with using transparent CNTs is that as the CNTs become more transparent, their electrical conductivity decreases. In an attempt to address this problem, Prof. Zakhidov utilized transparent CNTs from Canatu Ltd. in Finland in his experiments, obtaining a total transmission of 60% at a mediocre resistivity of 500 ohm/sq or more.

Dr. Zvi Yaniv (an inventor of the present application) participated at this symposium and asked Prof. Zakhidov what would be an ideal transparent conductive electrode for such applications. Prof. Zakhidov replied that the best type of this electrode would have over 80% transmission, desirably 85% transmission, and a resistivity of 1 ohm/sq or better.

### BRIEF DESCRIPTION OF THE DRAWINGS

FIG. 1 illustrates a process for applying a metal mesh to a substrate.

FIGS. 2A-2C illustrate a process in accordance with embodiments of the present invention.

FIG. 3 illustrates a tandem solar cell configured in accordance with embodiments of the present invention.

### DETAILED DESCRIPTION

Aspects of the present invention solve the following issues of organized metallic meshes on transparent substrates:

1) the open, not electrically conductive, spaces between the metallic lines;

2) the conflict between the metallic lines needing to be thicker to provide for the highest possible electrical conductivity, but needing to be very narrow in order to be invisible (or at least undetectable) to the naked eye (e.g., 10-20 micrometers), and as a consequence a proper passivation of these lines allowing high transparency and high electrical conductivity is not feasible, if not impossible.

For example, if a mesh is on a specific substrate, in order to make the spaces between the metallic lines also conductive, one needs to then deposit some transparent conductive layer in those spaces, or this layer needs to be deposited on the substrate before the mesh. The problem is that, other than utilizing ITO, alternative materials, for example organic transparent conductive materials, will adversely affect the overall transparency of the substrate. Furthermore, if one utilizes ITO, for example, to fill the spaces between the metallic mesh lines, due to the fact that ITO is deposited in a thin film form, the resultant product will suffer from a step coverage issue.

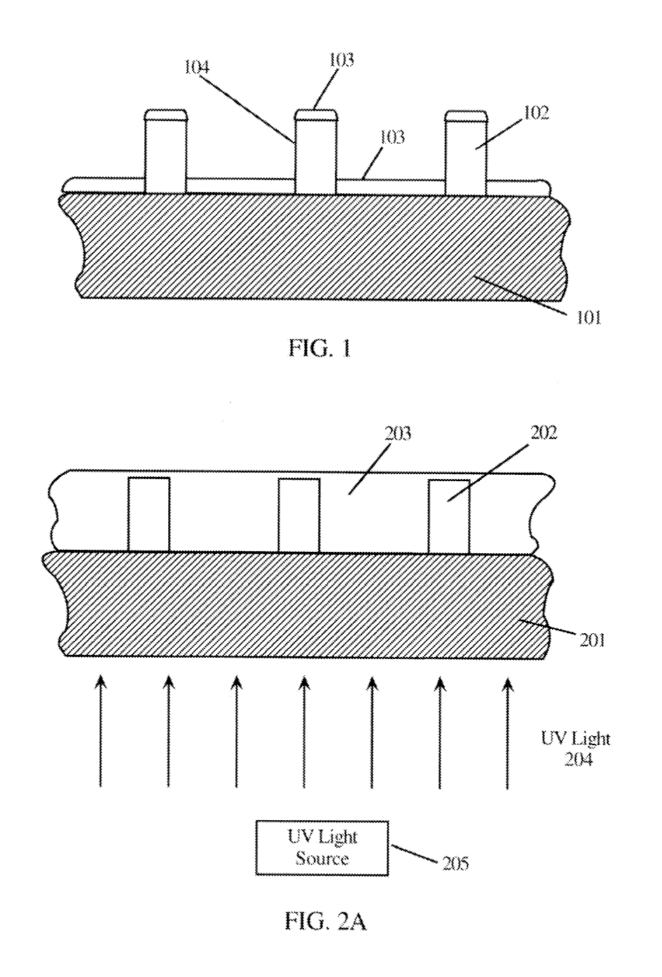

One solution could be to deposit a low quality ITO at lower deposition temperatures, in which case, due to the fact that this ITO layer would be very thin, a situation as illustrated in FIG. 1 will occur. In this case, the ITO 103 is deposited on the polymer substrate 101 and on the metallic lines 102 but not continuously, which will expose the side walls 104 of the metallic mesh 102.

When the side walls 104 are exposed, the ITO material 103 is not satisfactorily electrically connected to the metallic lines 102. As a result, many of the materials used for further manufacturing and assembly of display applications, electrochromic applications, etc., that act basically as a solvent, will etch away all or portions of the metallic lines 102, which will compromise the device functionality.

Indeed, initial experimentation with electrochromic materials clearly showed this effect, and such devices seized operation after a few hundred cycles. It is expected that this would be the case with liquid crystals and similar display materials.

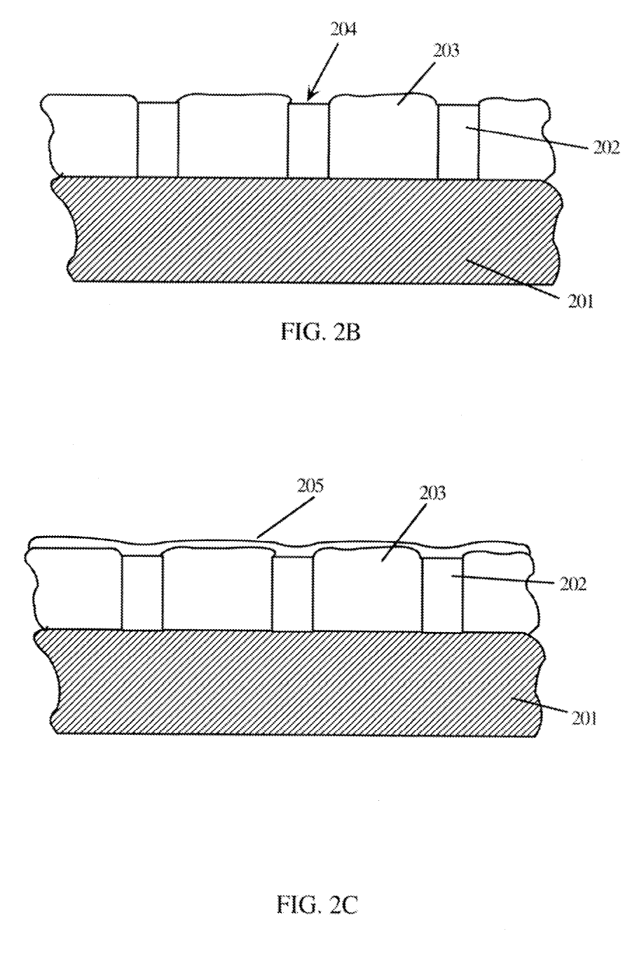

Embodiments of the present invention address the problem by planarization of the substrate, including the metallic mesh, before depositing a top transparent conductive layer (e.g., ITO). Referring to FIG. 2A, which illustrates a cross-section side view of an embodiment of the present invention, a UV-curable transparent material 203 (which may be of an organic material) is coated on the substrate 201 and the metallic mesh 202. The curable organic material 203 is then exposed to directional UV light 204 from a UV light source 205 from the back side of the substrate 201 utilizing the metallic lines 202 of the mesh as a mask. This results in the material 203 being cured, except for those portions above the mesh 202 that have been masked from the UV light by the mesh 202. Referring to FIG. 2B, the uncured organic material filler 202 that remains over each of the metallic lines 202 is removed, such as with a typical etching process, thus leaving exposed the tops of the mesh 202. Referring to FIG. 2C, a conductive material layer 205 (e.g., ITO), which may be thin (e.g., approximately 1000-3000 Å) and/or of a relatively low quality, is deposited over the mesh 202 and layer 203, which performs a couple of functions: (1) it solves a problem of the non-electrically conductive islands/spaces between the metallic lines 202 of the mesh and eliminates step coverage issues, and (2) it passivates the entire substrate 201 including the metallic mesh 202 and the organic filler 203, which resists etching away of the mesh lines 202 during subsequent display/solar cell, etc. manufacturing steps. Furthermore, the organic filler 203 provides additional support to the metallic lines 202 helping with the reliability of these metallic lines against breaking in the bending process of the substrate 201.

In an example, a TB3015B-UV curable adhesive available from Three Bond Co., Ltd. is used. The foregoing process is used to achieve the necessary results by UV exposure of the UV curable adhesive 203 from the back side of the substrate 201, meaning the metallic lines 202 are used as a photomask. The resin 203 can start the polymerization process when exposed to UV radiation in wavelength UV-AB region of the spectrum. Typically, an UV source using a high pressure mercury or mercury metal halide bulb will produce a suitable UV spectrum for good UV curing. The power output for a suitable UV cure unit should be adequate to affect UV curing in a reasonable time frame (usually <10 seconds). The radiated power of the UV source should be on the order of 1,000 mW/cm² to 4500 mW/cm² for the UV-A/B region. Curing speed results can be dependent on the spatial arrangement of the part of the UV source. UV power intensity (i.e., mW/cm²) and UV dose (i.e., mJ/cm²) measurements vary greatly depending on the distance between the part and UV source. The resin 203 will respond correctly when exposed to a prescribed UV dose listed for this product, plus/minus window of typically 250 mJ/cm².

The assignee has developed materials and processes to replace ITO for many applications utilizing metallic meshes on a substrate, such as described above.

The assignee has also developed different metallic inks that can be printed in contact or not in contact with the substrate at line widths of better than 20 micrometers, and easily achieving transmissions better than 80% and resistivities as low as 0.1 ohm/sq.

Incorporating the above, embodiments of the present invention utilize metallic mesh electrodes already printed on substrates or directly printed on the solar cell material to be used as an electrode. As a result, ITO or other transparent conductive material is not required, or a lower quality ITO may be utilized. Moreover, in a similar way, such a mesh electrode may be used as an intermediate electrode between two different types of cells to achieve low cost, high quality, parallel tandem solar cells. A similar approach may be used for solar cells connected in series where integration into one unit is desired.

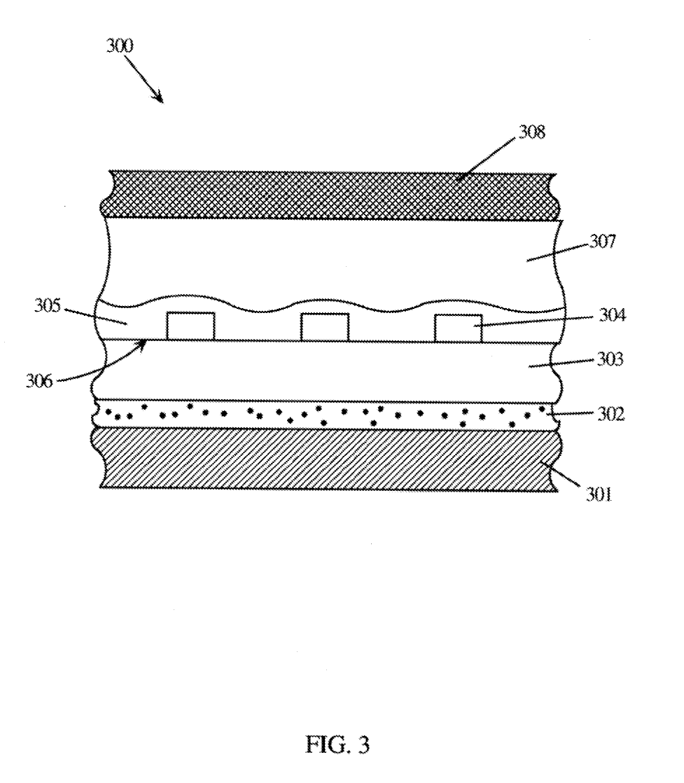

Referring to FIG. 3, a solar cell configuration 300 has a substrate 301, which may be transparent, and may be composed of any material compatible with solar cell materials. On substrate 301 may be deposited a transparent conductive film 302, which may comprise ITO, or any equivalent material, including the metallic mesh material as described herein with respect to FIGS. 2A-2C. Layer 303 comprises a first solar cell material for converting incident light of a first wavelength(s) into electrical energy, while layer 307 comprises a second solar cell material for converting incident light of a second wavelength(s) into electrical energy. Such solar cell materials are well-known in the art. The first and second wavelengths may be the same or substantially the same, or overlap each other, or they may be different. Layers 303 and 307 are separated by layer 306, which may comprise the metallic mesh 304 and filler 305, such as described herein with respect to FIGS. 2A-2C. Layer 308 (optional) may be an electrode. Layer 306 is configured to have transparency of 80% or greater and/or resistivity of 0.1 ohm/sq or substantially near it, or lower.

What is claimed is:

1. A method comprising:
applying a conductive mesh over a first side of a transparent substrate;
depositing a UV-curable transparent material over the conductive mesh and the first side of the transparent substrate;
exposing the UV-curable transparent material to UV light from a UV light source positioned in proximity to a second side of the transparent substrate, wherein the first and second sides of the transparent substrate are on opposite sides of the transparent substrate from each other, wherein the UV light emitted from the UV light source travels through the transparent substrate from the second side to the first side before being received by the UV-curable transparent material, wherein the UV-curable transparent material is cured in response to exposure from the UV light except for those portions of the UV-curable transparent material masked from exposure to the UV light by the conductive mesh;
removing those uncured portions of the UV-curable transparent material; and
depositing a transparent conductive material layer over the cured UV-curable transparent material and the conductive mesh.

2. The method as recited in claim 1, wherein the transparent conductive material layer is deposited on those portions of the conductive mesh from where the uncured portions of the UV-curable transparent material had been removed.

3. The method as recited in claim 2, wherein an electrically conductive connection is present between the conductive mesh and the transparent conductive material layer.

4. The method as recited in claim 3, wherein the transparent conductive material layer is an ITO layer.

5. The method as recited in claim 3, wherein the transparent conductive material layer is thinner than a thickness of the cured UV-curable transparent material filling in gaps between the conductive mesh.

6. The method as recited in claim 5, wherein a thickness of the transparent conductive material layer is 1000-3000 angstroms.

7. The method as recited in claim 1, wherein the UV light is emitted in a uni-directional manner from the UV light source through the transparent substrate towards the UV-curable transparent material.

8. The method as recited in claim 1, wherein the UV-curable transparent material is organic.

9. The method as recited in claim 1, wherein the UV-curable transparent material is deposited so that it substantially fills gaps between the conductive mesh to a thickness substantially equal to a distance from the transparent substrate to a position where the conductive mesh is located farthest from the transparent substrate.

10. The method as recited in claim 1, wherein the UV-curable transparent material is deposited so that it substantially fills gaps between the conductive mesh to a thickness slightly greater than a distance from the transparent substrate to a position where the conductive mesh is located farthest from the transparent substrate.
